(19) United States
(12) Patent Application Publication
(10) Pub. No.: US 2007/0186162 A1
(43) Pub. Date: Aug. 9, 2007

(54) File access apparatus

(76) Inventor: Junya Kaku, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/588,858

(22) PCT Filed: Jan. 11, 2005
(86) PCT No.: PCT/JP05/00449

§ 371 Date: Aug. 9, 2006

(30) Foreign Application Priority Data
Feb. 25, 2004 (JP) 2004-49576

(51) Int. Cl. G06F 3/00

(52) U.S. Cl. 715/721

(57) ABSTRACT

A file access apparatus (10) includes a CPU (36). The CPU (36) accesses an MPEG file under control of a multi-task OS. The MPEG file contains MPEG data on a plurality of frames forming a moving image and index information used for managing the MPEG data. The CPU (36) causes an index task to issue an index readout instruction for reading out the index information from the MPEG file, and causes a main task to issue a frame readout instruction for reading out the MPEG data from the MPEG file. The frame readout instruction is issued with reference to the index information read out in accordance with the index readout instruction. Access to the MPEG file in accordance with the thus issued index readout instruction or the frame readout instruction is executed by a BG task.

### TECHNICAL FIELD

The present invention relates to a file access apparatus. More specifically, the present invention relates to a file access apparatus that is applied to a digital video camera and makes access to an image file containing image data on a plurality of screens forming a moving image and index information used for managing the image data on a plurality of screens.

### PRIOR ART

One example of file access apparatus of this conventional type is disclosed in Japanese Patent Laying-open No. 2001-257993 laid-open on Sep. 21, 2001. According to this prior art, in reproducing a moving image file, index information on each of frames forming a moving image is firstly detected from the moving image file, and then the detected index information is set to an index information table. The image data on the frames are sequentially reproduced with reference to the thus prepared index information table.

With the prior art, however, it is required to detect all the index information before starting reproduction of the moving image. Thus, the longer hours it takes to reproduce a moving image, the more a time of waiting for start of reproduction is lengthened.

### SUMMARY OF THE INVENTION

Therefore, it is a primary object of the present invention to provide a novel file access apparatus.

It is another object of the present invention to provide a file access apparatus that allows reproduction of a moving image to be rapidly started.

A file access apparatus according to claim 1 makes access to an image file containing image data on a plurality of screens forming a moving image and index information data used for managing the image data on the plurality of screens under control of a CPU executing a plurality of tasks in parallel based on a multi-task OS. The plurality of tasks includes a first instruction issue task of issuing a first readout instruction for reading out the index information from the image file, a second instruction issue task of issuing a second readout instruction for reading out the image data from the image file with reference to the index information read out under the first readout instruction, and an access task of making access to the image file in accordance with each of the first readout instruction issued by the first instruction issue task and the second readout instruction issued by the second instruction issue task.

The image file contains image data on a plurality of screens forming a moving image and index information used for managing the image data on the plurality of screens. Access to the image file is executed under control of a CPU for executing a plurality of tasks in parallel based on a multi-task OS. More specifically, the first readout instruction for reading out the index information from the image file is issued by the first instruction issue task, and the second readout instruction for reading the image data from the image file is issued by the second instruction issue task. Here, the second readout instruction is issued with reference to the index information read out by the first readout instruction. The access task is executed to make access to the image file in accordance with each of the first readout instruction and second readout instruction thus issued.

The operation required for reproduction of the image data is divided among a plurality of tasks in the above described manner. Therefore, it is possible to start the readout of the image before the readout of all the index information is completed, which allows rapid reproduction of a moving image.

According to a file access apparatus of claim 2 depending on claim 1, the access task includes an access suspension for suspending the access in accordance with the first readout instruction until completion of the access in accordance with the issued second readout instruction, and the second instruction issue task includes an issue suspension process for suspending issue of the second readout instruction when the index information to be referred to is not yet read out.

The access in accordance with the first readout instruction, i.e., the readout of the index information is suspended until after completion of the access in accordance with the issued second readout instruction, i.e., the readout of desired image data. Meanwhile, the issue of the second readout instruction is suspended when the index information to be referred to is not yet read out. This allows the readout timing of the image data and index information to be accurately controlled.

According to a file access apparatus of claim 3 depending on claim 1 or 2, the first instruction issue task allows an issue process of the first readout instruction to be started prior to issue of the second readout instruction by the second instruction issue task.

This allows a part of the index information to be read prior to reading of the image data.

According to a file access apparatus of claim 4 depending on any one of claims 1 to 3, the first instruction issue task allows issue of the first readout instruction to be started when accepting a selection operation for selecting the image file, and the second instruction issue task allows issue of the second readout instruction to be started when accepting a start operation for starting readout of the image data. An issue amount of the first readout instruction depends on the timing of the start operation.

According to a file access apparatus of claim 5 depending on claim 4, the start operation is carried out after the selection operation.

According to a file access apparatus of claim 6 depending on any one of claims 1 to 5, the index information is prepared for each screen. This allows output control of image data for each screen.

A file access apparatus of claim 7 depending on any one of claims 1 to 6, further comprises a display means for displaying an image based on the image data read out in accordance with the second readout instruction.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is an illustrative view showing a relationship between a reference position and an offset;

FIG. 3 is an illustrative view showing one example of structure of a moving image file created by FIG. 1 embodiment;

FIG. 4 is an illustrative view showing one example of a file list displayed on an LCD;

FIG. 5 is an illustrative view showing one example of a mapping state of an SDRAM applied to FIG. 1 embodiment;

FIG. 6 is an illustrative view showing one example of an index information table applied to FIG. 1 embodiment;

FIG. 7 is an illustrative view showing one example of an instruction list applied to FIG. 1 embodiment;

FIG. 8 is an illustrative view showing one example of another instruction list applied to FIG. 1 embodiment;

FIG. 9 is a flowchart showing a part of an operation of FIG. 1 embodiment;

FIG. 10 is a flowchart showing another part of the operation of FIG. 1 embodiment;

FIG. 11 is a flowchart showing still another part of the operation of FIG. 1 embodiment;

FIG. 12 is a flowchart showing further another part of the operation of FIG. 1 embodiment; and

FIG. 13 is flowchart showing another part of the operation of FIG. 1 embodiment.

### BEST MODE FOR PRACTICING THE INVENTION

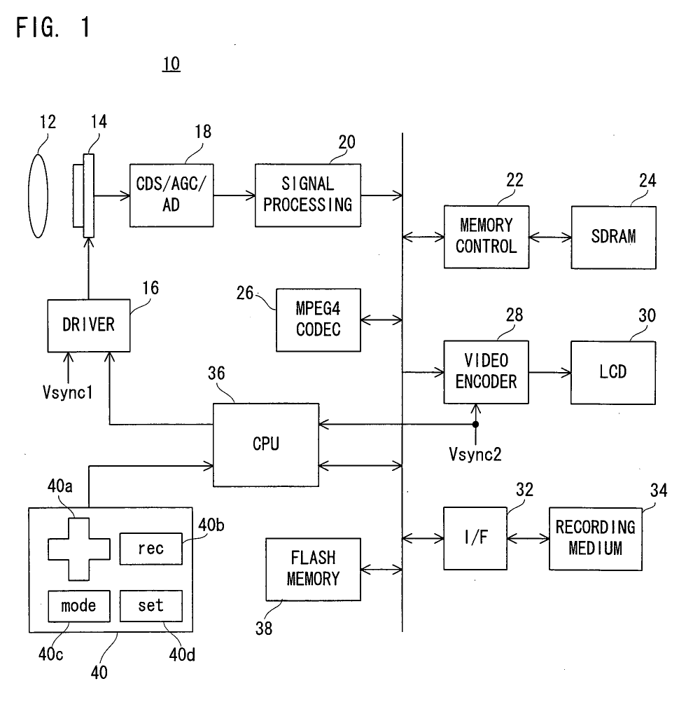

Referring to FIG. 1, a digital video camera 10 of this embodiment includes a focus lens 12. An optical image of an object scene is irradiated onto an imaging surface of an image sensor 14 through the focus lens 12. On the imaging surface, an electric charge corresponding to the optical image of object scene, that is, a raw image signal is generated by photoelectric conversion.

When a camera mode is selected by a mode key 40c provided on a key entry device 40, a through image process, that is, a process for displaying a real-time moving image of the object scene on an LCD monitor 30 is carried out. A CPU 36 firstly instructs a driver 16 to repeat pre-exposure and thinned-out readout. The driver 16 repeatedly executes pre-exposure of the image sensor 14 and thinned-out readout of a resultant raw image signal. The pre-exposure and thinned-out readout are carried out in response to a vertical synchronization signal Vsync1 generated at intervals of 1/30 second. This allows a raw image signal corresponding to the optical image of the object scene to be output from the image sensor 14 at a frame rate of 30 fps.

The output raw image signal on each of frames is subjected by a CDS/AGC/AD circuit 18 to a series of processes of noise removal, level adjustment and A/D conversion, thereby acquiring raw image data as a digital signal. The signal processing circuit 20 subjects the raw image data output from the CDS/AGC/AD circuit 18 to such processes as white balance adjustment, color separation and YUV conversion to generate image data in YUV format. The generated image data on each of the frames is written by a memory control circuit 22 into an SDRAM 24.

A video encoder 28 reads out image data on one frame from the SDRAM 24 through the memory control circuit 22 each time a vertical synchronization signal Vsync2 of 30 fps is generated. The read image data is converted into a composite video signal in the NTSC format, and the converted composite video signal is provided to the LCD monitor 30. As a result, a through image of the object scene is displayed on a monitor screen. In addition, although a description is omitted below as appropriate, access to the SDRAM 24 is always made through the memory control circuit 22.

When a moving image record key 40b is operated, the CPU 36 gives a compression instruction to an MPEG4 codec 26 for each generation of the vertical synchronization signal Vsync2. The MPEG4 codec 26 reads out image data on one frame from the SDRAM 24 each time the compression instruction is given, and subjects the read image data to a compression process according to a simple profile in MPEG4 format. The MPEG data generated by the compression process is then written into the SDRAM 24.

Besides, in the MPEG4 format, the image data is subjected to intra coding at intervals of approximately 15 frames, and subjected to inter coding on the remaining frames. A frame subjected to the intra coding is defined as “I frame”, and a frame subjected to the inter coding is defined as “P frame”.

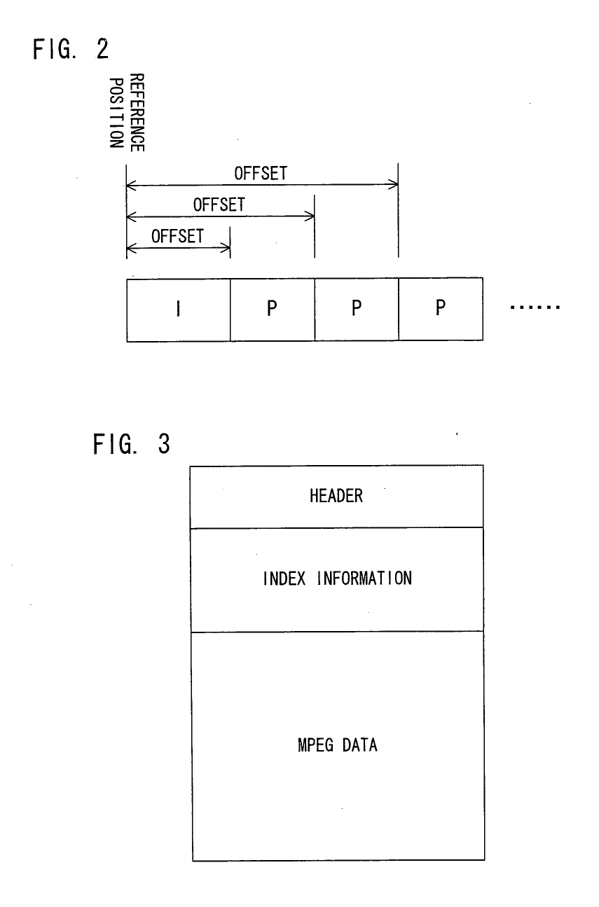

Each time MPEG data on one frame is generated, the CPU 36 acquires a size of the MPEG data from the MPEG4 codec 26, calculates an offset from a reference position to a beginning of the MPEG data, and writes index information including the determined size and offset into the SDRAM 24. Besides, the reference position is assigned to the beginning of the MPEG data on the first frame as shown in FIG. 2, and the offset of the MPEG data on the first frame is “0”.

In order to record in a recording medium 34 the MPEG data and index information thus accumulated in the SDRAM 24, the CPU 36 sets corresponding record instructions in an instruction list (not shown). The CPU 36 is a multi-task CPU that executes a multi-task OS such as μITRON, and the record instructions set in the instruction list are carried out by a BG task for recording (BG: Back Ground). The MPEG data and index information are recorded in the recording medium 34 through execution of the BG task. This creates an MPEG file shown in FIG. 3 within the recording medium 34.

When the moving image record key 40b is operated again, the CPU 36 terminates issue of the compression instruction to the MPEG4 code 26, and sets in the instruction list record instructions for the remaining MPEG data and index information in the SDRAM 24. Execution of the record instructions completes an MPEG file.

In addition, the recording medium 34 is a detachable semiconductor memory that can be accessed by an I/F 32 when inserted into a slot not illustrated.

When a reproduction mode is selected by the mode key 40c, the CPU 36 executes a main task, an index task and a BG task for reproduction in parallel.

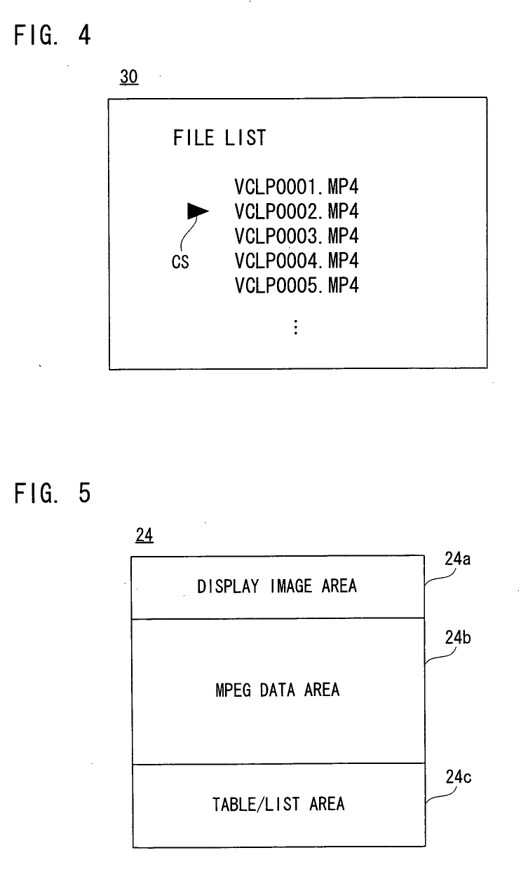

In the main task, file names of the MPEG files recorded in the recording medium 34 are firstly detected, and a file list of the detected file names is output. The file list is displayed on the LCD 30 in such a manner shown in FIG. 4, and a desired file name is pointed at by a cursor CS. When a desired MPEG file is selected here through operation of a cross key 40a and a set key 40d, the index task is activated.

In the index task, an index readout instruction for transferring index information on each frame from the recording medium 34 to the SDRAM 24 is set in an instruction list 24f shown in FIG. 8 (instruction list 1). According to FIG. 8, the index readout instruction is defined by address information describing a readout start address and size information describing a readout size. Since a header size of the MPEG file shown in FIG. 3 is a fixed value and a size of the index information on each frame is also fixed value, the readout start address is uniquely identified by frame number.

The index readout instruction is executed by the BG task. With this, index information on each of the frames is read out from the MPEG file and set in the index information table 24d shown in FIG. 6. According to FIG. 6, the size and offset of the MPEG data on each of the frames are assigned to the frame number.

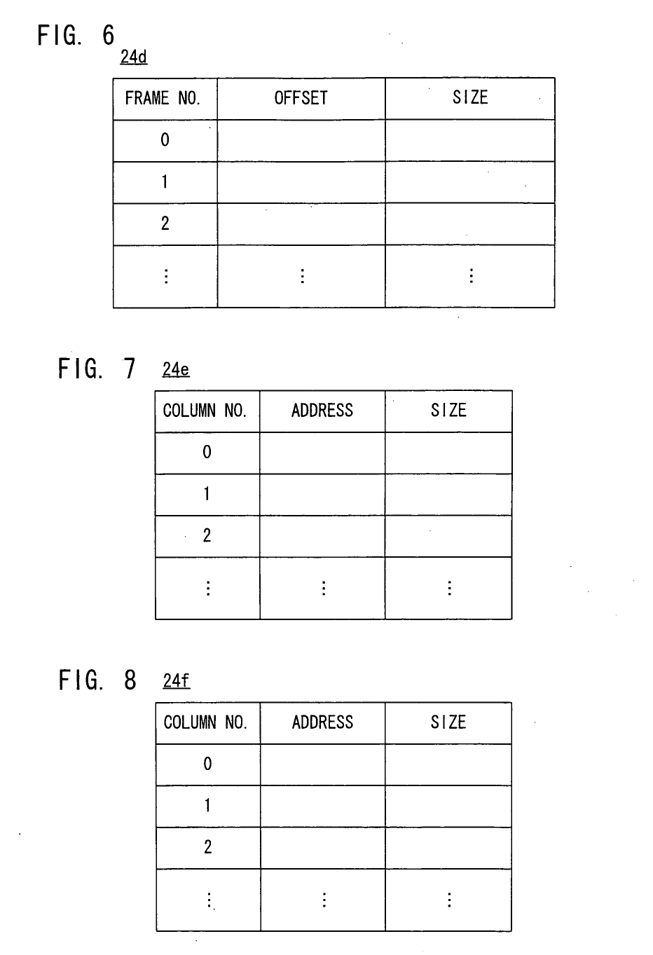

In the main task, a frame readout instruction for transferring the MPEG data on each of the frames from the recording medium 34 to the SDRAM 24 is set in an instruction list 24e (instruction list 0) shown in FIG. 7. As described above, the frame readout instruction is also defined by the address information describing a readout start address and the size information describing a readout size. The readout start address and the readout size are here identified with reference to the index information table 24d. Especially, the readout start address can be determined by adding together the first address of the MPEG data contained in the MPEG file and the offset set in the index information table 24d.

The frame readout instruction thus set is also executed by the BG task. With this, the MPEG data on each of the frames is transferred from the MPEG file to the SDRAM 24.

When the reproduction mode is selected, the SDRAM 24 is mapped as shown in FIG. 5. According to FIG. 5, a display image area 24a, an MPEG data area 24b and a table/list area 24c are formed on the SDRAM 24. The above mentioned index information table 24d and instruction lists 24e and 24f are formed on the table/list area 24c. Also, the MPEG data read out from the recording medium 34 is stored in the MPEG data area 24b.

In the main task, a decompression instruction is issued to the MPEG4 codec 26 each time a vertical synchronization signal is generated from the video encoder 28. The MPEG4 codec 26 reads out MPEG data on a desired frame from the MPEG data area 24b of the SDRAM 24, decompresses the read MPEG data, and writes the decompressed image data into the display image area 24a of the SDRAM 24. The decompressed image data is read out from the display image area 24a and is converted into a composite video signal by the video encoder 28. The LCD 30 displays an image based on the converted composite video signal.

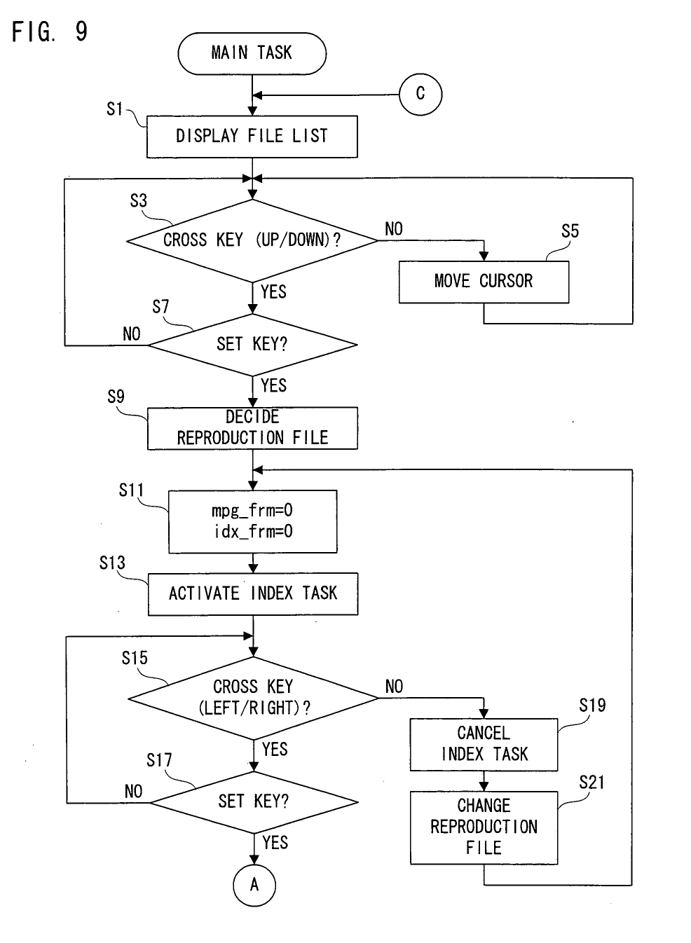

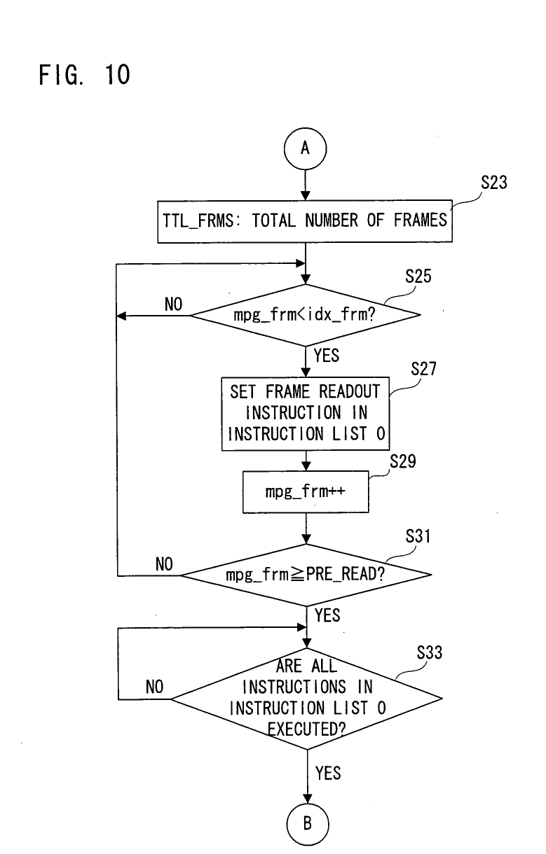

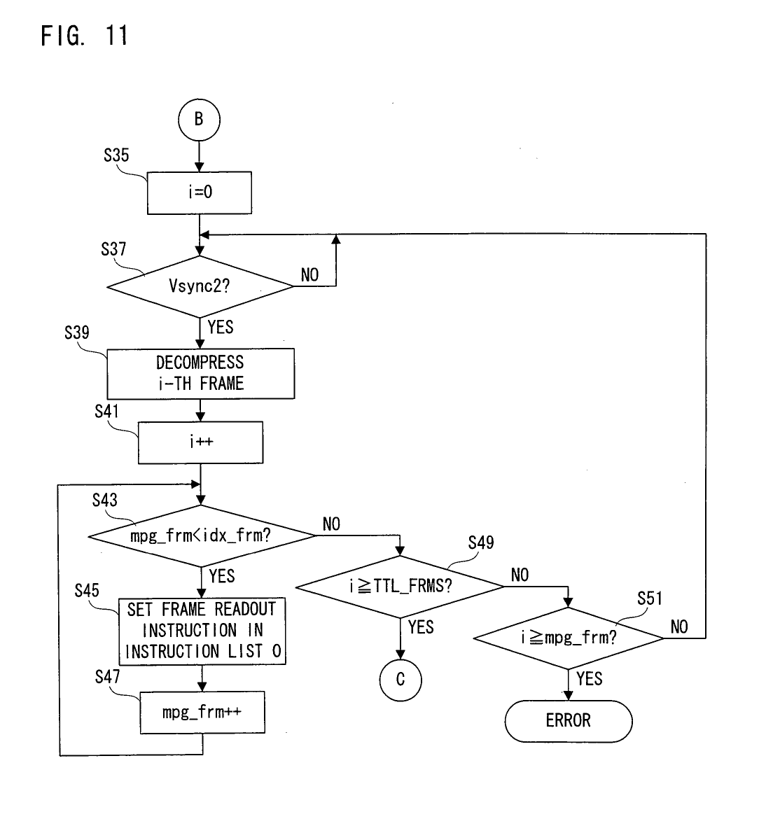

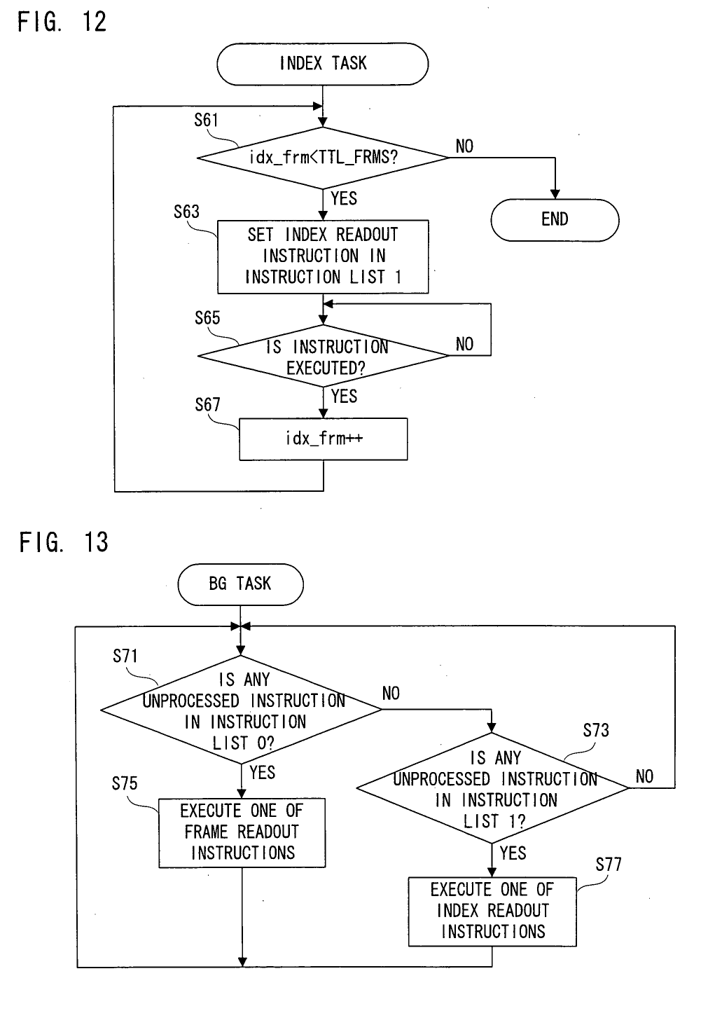

A description will be given below as to a processing operation of the CPU 36 in the reproduction mode with reference to FIG. 9 to FIG. 13. Here, a flowchart shown in FIG. 9 to FIG. 11 represents the main task, a flowchart shown in FIG. 12 the index task, and a flowchart shown in FIG. 13 the BG task for reproduction. Besides, control programs corresponding to these flowcharts are stored in a flash memory 38.

Referring to FIG. 9 to FIG. 11, in a step S1, the file names of MPEG files recorded in the recording medium 34 are detected, and a file list of the detected file names is output from the LCD 30 in a manner shown in FIG. 4.

It is determined in a step S3 whether the cross key 40a is operated in an up/down direction or not, and it is determined in a step S5 whether the set key 40d is operated or not. When the cross key 40a is operated in the up/down direction, the process goes from the step S3 to the step S5, and the cursor CS is moved on the screen in a desired direction. Upon completion of the movement, the process returns to the step S3. When the set key 40d is operated, the process goes from a step S7 to a step S9 to decide an MPEG file pointed at by the cursor CS as a reproduction file.

In a step S11, variables mpg_frm and idx_frm are set at “0”. The variable mpg _frm indicates the frame number of MPEG data to be read out from the recording medium 34, and the variable idx_frm denotes the frame number of index information to be read out from the recording medium 34. Upon completion of the process of the step S11, the index task is activated in a step S13.

It is determined in a step S15 whether or not the cross key 40a is operated in a right /left direction, and it is determined in a step S17 whether the set key 40d is operated or not. If the cross key 40a is operated in the right/left direction, the determination result is YES in the step S15, and the index task is canceled in a step S19. This cancellation forcedly terminates the index task. In a succeeding step S21, the reproduction file is changed to another MPEG file, and the process returns to the step S11 afterward.

If the set key 40d is operated, the process moves from the step S17 to a step S23 in which the total number of frames of MPEG data contained in the reproduction file is set to a variable TTL_FRMS. In a step S25, the variable mpg_frm is compared with the variable idx_frm. If the variable mpg_frm is below the variable idx_frm, the process goes to a step S27 in which the frame readout instruction is set in the instruction list 24e shown in FIG. 7. If the variable mpg_frm has reached the variable idx_frm, the process of step S25 is repeated.

For setting of the frame readout instruction directed to MPEG data on a certain frame (e.g. 10th frame), the index information on this frame (10th frame) must be already obtained in the index information table 24d. The determination result of NO in the step S25 means that the required index information is not obtained in the index information table 24d, and the determination result of YES in the step S25 indicates that the required index information is obtained in the index information table 24d.

The variable mpg_frm is incremented in a step S29, and the variable mpg_frm is compared with a threshold value PRE_READ (=300) in a step S31. If the variable mpg_frm is below the threshold value PRE_READ, the process returns to the step S25. If the variable mpg_frm has reached the threshold value PRE_READ, the process moves to a step S33. In the step S33, it is determined whether all the frame readout instructions set in the instruction list 24e are carried out or not. If YES here, it is concluded that the MPEG data of 10 seconds has been transferred to the SDRAM 24, and the process moves to a step S35 and later.

In the step S35, a variable i indicative of a reproduction frame number is set to “0”. In a step S37, it is determined whether a vertical synchronization signal has been output from the video encoder 28 or not. If YES, the MPEG4 codec 26 is instructed to decompress MPEG data on an i-th frame in a step S39.

The MPEG4 codec 26 reads out the MPEG data on the i-th frame from the SDRAM 24, decompresses the read MPEG data, and then writes the decompressed image data into the SDRAM 24. The decompressed image data is read out from the SDRAM 24 and converted into a composite video signal by the video encoder 28. As a result, an image of i-th frame is displayed on the LCD 30.

The variable i is incremented in a step S41, and the variable mpg_frm is compared with the variable idx_frm in a succeeding step S43. If the variable mpg_frm is below the variable idx_frm, the process moves from the step S43 to a step S45, and the frame readout instruction directed to the variable mpg_frm is set in the instruction list 24e. When setting of the frame readout instruction is completed, the variable mpg_frm is incremented in a step S47, and the process returns to the step S43.

If the variable mpg_frm has reached the variable idx_frm, the determination result is NO in the step S43, and the variable i is compared with the variables TTL_FRMS and mpg_frm in steps S49 and S51, respectively. If the variable i has reached the variable TTL_FRMS, it is concluded that reproduction of the MPEG data on all the frames is completed, and then the process returns to the step S1. If the variable i has reached the variable mpg_frm, it is concluded that an error has occurred, and the process goes to error handling. If the variable i is less than the variable mpg_frm, the process returns to the step S37 to continue reproduction of the moving image.

Referring to FIG. 12, the variable idx_frm is compared with the variable TTL _FRMS in a step S61. If the variable idx_frm is below the variable TTL_FRMS, the process moves to a step S63, the index readout instruction directed to the variable idx_frm is set in the instruction list 24f. In a step S65, it is determined whether the set index readout instruction is carried out or not. If YES here, the variable idx_frm is incremented in a step S67, and then the process returns to the step S61. If the variable idx _frm has reached the variable TTL_FRMS, it is concluded that all the index readout instructions are set in the instruction list 24f, and then the index task is terminated.

Referring to FIG. 13, it is determined in a step S71 whether or not there exists any instruction not yet processed in the instruction list 24e, and it is determined in a step S73 whether or not there exists any instruction not yet processed in the instruction list 24f. If YES in the step S71, the process goes to a step S75 to execute one of the frame readout instructions set in the instruction list 24e. If YES in the step S73, the process goes to a step S77 to execute one of the index readout instructions set in the instruction list 24f. Upon completion of the process of step S75 or S77, the process returns to the step S71. Therefore, execution of an index readout instruction is suspended until after all the set frame readout instructions have been carried out.

As can be understood from the above description, the MPEG file contains MPEG data on a plurality of frames forming a moving image and index information used for managing the MPEG data. Access to the MPEG file is carried out under control of the CPU 36 with a multi-task OS. More specifically, the CPU 36 causes the index task to issue the index readout instruction for reading out the index information from the MPEG file, and causes the main task to issue the frame readout instruction for reading out the MPEG data from the MPEG file. Besides, the frame readout instruction is issued with reference to the index information read out in accordance with the index readout instruction. Access to the MPEG file in accordance with each of the index readout instruction and the frame readout instruction thus issued is executed by the BG task.

By dividing the operation required for reproduction of the MPEG data among a plurality of tasks in the above mentioned manner, the readout of the MPEG data is started before the readout of all the index information is completed. This allows reproduction of a moving image to be rapidly started.

In addition, the readout of the index information is suspended until after all the issued frame readout instructions have been executed (S71, S75). Meanwhile, the issue of a frame readout instruction is suspended when the index information to be referred to is not yet read out (S25, S43). With this, the timing to read out the MPEG data and the index information is accurately controlled.

Moreover, in this embodiment, the image data compressed in the MPEG4 format is reproduced. Alternatively, the image data may be compressed in the M-JPEG format or may not be compressed.

Although the present invention has been described and illustrated in detail, it is clearly understood that the same is by way of illustration and example only and is not to be taken by way of limitation, the spirit and scope of the present invention being limited only by the terms of the appended claims.

1. A file access apparatus for making access to an image file in which image data on a plurality of screens forming a moving image and index information used for managing said image data on the plurality of screens are contained, under control of a CPU executing a plurality of tasks in parallel based on a multi-task OS, wherein
said plurality of tasks include:
a first instruction issue task of issuing a first readout instruction for reading out said index information from said image file;
a second instruction issue task of issuing a second readout instruction for reading out the image data from said image file with reference to the index information read out in accordance with said first readout instruction; and
an access task of making access to said image file in accordance with each of the first readout instruction issued by said first instruction issue task and the second readout instruction issued by said second instruction issue task.

2. A file access apparatus according to claim 1, wherein said access task includes an access suspension process for suspending the access in accordance with said first readout instruction until after completion of the access in accordance with the issued second readout instruction, and said second instruction issue task includes an issue suspension process for suspending issue of said second readout instruction when the index information to be referred to is not yet read out.

3. A file access apparatus according to claim 1, wherein said first instruction issue task allows an issue process of said first readout instruction to be started prior to issue of said second readout instruction by said second instruction issue task.

4. A file access apparatus according to claim 1, wherein said first instruction issue task allows issue of said first readout instruction to be started when accepting a selection operation for selecting said image file, and said second instruction issue task allows issue of said second readout instruction to be started when accepting a start operation for starting readout of said image data.

5. A file access apparatus according to claim 4, wherein said start operation is carried out after said selection operation.

6. A file access apparatus according to claim 1, wherein said index information is prepared for each screen.

7. A file access apparatus according to claim 1, further comprising a display means for displaying an image based on the image data read out in accordance with said second readout instruction.

8. A file access apparatus according to claim 2, wherein said index information is prepared for each screen.

9. A file access apparatus according to claim 3, wherein said index information is prepared for each screen.

10. A file access apparatus according to claim 4, wherein said index information is prepared for each screen.

11. A file access apparatus according to claim 5, wherein said index information is prepared for each screen.

12. A file access apparatus according to claim 2, further comprising a display means for displaying an image based on the image data read out in accordance with said second readout instruction.

13. A file access apparatus according to claim 3, further comprising a display means for displaying an image based on the image data read out in accordance with said second readout instruction.

14. A file access apparatus according to claim 4, further comprising a display means for displaying an image based on the image data read out in accordance with said second readout instruction.

15. A file access apparatus according to claim 5, further comprising a display means for displaying an image based on the image data read out in accordance with said second readout instruction.

16. A file access apparatus according to claim 2, wherein said first instruction issue task allows an issue process of said first readout instruction to be started prior to issue of said second readout instruction by said second instruction issue task.

17. A file access apparatus according to claim 2, wherein said first instruction issue task allows issue of said first readout instruction to be started when accepting a selection operation for selecting said image file, and said second instruction issue task allows issue of said second readout instruction to be started when accepting a start operation for starting readout of said image data.

18. A file access apparatus according to claim 3, wherein said first instruction issue task allows issue of said first readout instruction to be started when accepting a selection operation for selecting said image file, and said second instruction issue task allows issue of said second readout instruction to be started when accepting a start operation for starting readout of said image data.
